(19) United States
(12) Patent Application Publication
(10) Pub. No.: US 2005/0233058 A1
(43) Pub. Date: Oct. 20, 2005

(54) Aminoacid derivatives of dicarboxylic acids as flavor ingredients

(76) Inventors: Eric Frerot, Ville La Grand (FR); Francois Benzi, Chenex (FR)

Correspondence Address: WINSTON & STRAWN LLP, 1700 K STREET, N.W., WASHINGTON, DC, 20006, US

(21) Appl. No.: 11/150,778

(22) Filed: Jun. 9, 2005

Related U.S. Application Data
(63) Continuation of application No. PCT/IB04/00258, filed on Jan. 29, 2004.

(51) Int. Cl. A23L 1/221

(52) U.S. Cl. 426/650

(57) ABSTRACT

The present invention relates to the use of a derivative of a amino acid and a diacid as a flavoring ingredient. In particular, these compounds are particularly useful as mouthfeel or umami agents or as a partial or total replacer for monosodium glutamate (MSG).

### CROSS-REFERENCE TO RELATED APPLICATIONS

This application is a continuation of International application PCT/IB2004/000258 filed 29 Jan. 2004, the entire content of which is expressly incorporated herein by reference thereto.

### TECHNICAL FIELD

The present invention relates to the field of flavors and in particular it concerns the flavoring of an article upon which it is desired to confer or enhance the fullness and harmony of its taste or aroma, i.e. a mouthfeel.

### BACKGROUND

Almost all the invention's compounds are known. Said compounds have been mentioned in various contexts, for example about their presence in plant seeding or in the catabolism of some microorganisms.

However, to the best of our knowledge, none of these compounds has been described for a use as flavoring ingredient, and even less as an umami and/or mouthfeel flavoring agent.

### SUMMARY OF THE INVENTION

The invention now relates more particularly to a method to confer, enhance, improve or modify the flavor properties of a flavoring composition or of a flavored article, which method comprises adding to said composition or article an effective amount of at least one compound selected from the group consisting of
(a) an acid of formula

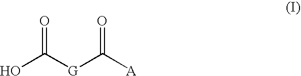

wherein G represents a linear C₁ to C₆ alkyl group or a HC═CH group having the carbon-carbon double bond in a E or Z configuration; and

A represents a proteogenic α-amino acid residue, said residue being bonded to the carbonyl group via the α-nitrogen atom; and

(b) the edible alkaline or alkaline earth metal salts, and the hydrates, of said compounds of formula (I).

The invention also relates to the flavoring compositions or the flavored articles containing, as flavoring ingredients, at least one of the invention's compounds.

### DETAILED DESCRIPTION OF THE PREFERRED EMBODIMENTS

Surprisingly, we have now been able to establish that the use as flavoring ingredient of at least one compound selected from the group consisting of
(a) an acid of formula

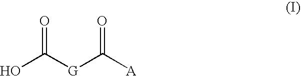

wherein G represents a linear C₁ to C₆ alkyl group or a HC═CH group having the carbon-carbon double bond in a E or Z configuration; and

A represents a proteogenic a-amino acid residue, said residue being bonded to the carbonyl group via the a-nitrogen atom; and

(b) the edible alkaline or alkaline earth metal salts, and the hydrates, of said compounds of formula (I),

is particularly useful to the flavor industry. In particular, the use as mouthfeel and/or umami agent and/or as a monosodium glutamate (MSG) partial or total replacer is particularly attractive.

Said uses consist, for example, in a method to impart, improve or increase the umami character and/or the mouthfeel of a flavoring composition or a flavored article, which method comprises adding to said composition or article an umami and/or mouthfeel effective amount of at least an invention's compound.

By “mouthfeel agent” we mean here a flavoring ingredient capable of modifying, imparting, improving or enhancing the taste properties of flavoring compositions or foodstuffs to which they are added, and this in respect of the “mouth impact” of the aroma of said flavoring compositions or foodstuffs. In other words, a “mouthfeel agent” according to the invention provides an effect on the roundness and fullness perception of the aroma or taste of products into which it is added.

By “umami agent” we mean here a flavoring ingredient capable of imparting what is commonly defined by a skilled person of the art as the umami taste.

The term “α-amino acid residue” mentioned above has the meaning common in the art, that is an α-amino acid that lacks a hydrogen atom of the α:amino group, i.e. the group —(HN—CHR—COOH). These residues will henceforth be represented by the three letter abbreviations shown in brackets hereinbelow, which are of current use for defining the structure of polypeptide chains (see, e.g., Eur. J. Bioch. 1984, 138, 9-37). For the sake of clarity, it has to be mentioned also that by “proteogenic α-amino acid” we mean here any of the twenty amino acids used in nature for the synthesis of proteins. Said amino acids are: L-glycine (Gly), L-alanine (Ala), L-valine (Val), L-leucine (Leu), L-isoleucine (Ile), L-proline (Pro), L-serine (Ser), L-threonine (Thr), L-phenylalanine (Phe), L-tyrosine (Tyr), L-tryptophan (Trp), L-lysine (Lys), L-arginine (Arg), L-histidine (His), L-aspartic acid (Asp), L-glutamic acid (Glu), L-asparagine (Asn), L-glutamine (Gln), L-cysteine (Cys) and L-methionine (Met).

This invention is therefore concerned with compounds including a C₃ to C₈ dicarboxylic moiety and a residue of proteogenic amino acids mentioned above. Thus, and to provide a specific example, the invention's derivative N-(3-carboxypropionyl)-glutamic acid, or succinoyl-Glu, has the following structure:

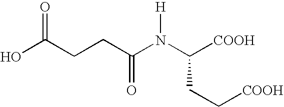

The most interesting organoleptic property of the invention's compounds is their ability to impart highly appreciated umami and/or mouthfeel characteristics to the compositions or foodstuffs to which they are added. More specifically, the mouthfeel or mouth impact provided by the presence of the invention's compounds results in a quite remarkable roundness, fullness and harmony of the whole taste of the flavoring compositions or flavored articles. It has to be said that the overall organoleptic effect is different from the one which could be obtained by compounds consisting of a simple salt between the free diacid and the free amino acid, which have a much sharper taste associated with the acid taste and are not able to impart an umami and mouthfeel character to the food in which they are added.

Such behavior makes the invention's compounds useful partial or total replacer of MSG, which is a known mouthfeel agent, in the food industry. However, the whole organoleptic effect provided by the invention's compounds is less sweet than the one provided by MSG, and therefore offers another tool for flavor creation.

According to a particular embodiment of the invention, the compounds of formula (I) wherein G represents a CH₂CH₂, CH₂CH₂CH₂ or HC═CH group, and A represents the residue of the α-amino acid Ala, Leu or Glu, as well as the corresponding hydrates or edible alkaline or alkaline earth metal salts, have proved to be remarkably useful for a use according to the invention. In particular the succinoyl derivatives of Glu, Ala or Leu, i.e. N-(3-carboxypropionyl)glutamic acid (succinoyl-Glu), N-(3-carboxypropionyl)-leucine (succinoyl-Ala), N-(3-carboxypropionyl)leucine (succinoyl-Leu) or their hydrates or edible salts, have shown a very good performance as MSG replacer and/or as mouthfeel and/or umami agents, and are able to provide flavoring compositions and flavored articles with very much appreciated organoleptic characteristics.

For example, succinoyl-Glu possesses a slightly acidic note together with a well perceivable umami taste or character having a broth connotation, the overall organoleptic impression being accompanied by a good and long lasting roundness and fullness. The compounds succinoyl-Leu and succinoyl-Ala, which have a slightly more acidic and slightly less umami taste than the one of succinoyl-Glu, provide similar organoleptic effects. Moreover, the organoleptic effect of these compounds has been found to be less sweet than the one provided by MSG, conferring thus an advantage to the invention's compounds for a use in savory application, wherein a sweet note may be undesired.

One may also cite the compounds (Z)-N-(3-carboxy-2-propenoyl)-L-glutamic acid, N-(4-carboxybutanoyl)L-glutamic acid and N-(4-carboxybutanoyl)-L-leucine (Maleyl-Glu, glutaryl-Glu, Glutaryl-Leu respectively) which are capable of imparting similar umami and mouthfeel effect than the succinoyl-Glu. However, in a meet type application, Maleyl-Glu imparts also a slightly more juicy feeling, while glutaryl-Glu and Glutaryl-Leu imparts also a slightly more fatty feeling.

It is important to point out that the compounds of formula (I), and their above-cited salts or hydrates, may be used in conformity with the invention scope also in the form of a flavoring composition, which can be advantageously employed in the flavor industry.

Therefore another object of the present invention is a flavoring composition comprising:

i) at least one invention's compound as defined above;

ii) at least one ingredient selected from the group consisting of a flavor carrier and a flavor base; and

iii) optionally at least one flavor adjuvant.

An invention's composition consisting of at least one invention's compound and at least one flavor carrier represents a particular embodiment of the invention as well as a flavoring composition comprising at least one invention's compound, at least one flavor carrier, at least one flavor base, and optionally at least one flavor adjuvant.

By “flavor carrier” we mean here a material which is practically neutral from a flavor point of view, i.e. which does not alter significantly organoleptic properties of flavoring ingredients. Said carrier may be a liquid or a solid.

As liquid carrier one may cite, as non-limiting examples, an emulsifying system or a solvent commonly used in flavors. A detailed description of the nature and type of solvents commonly used in flavor bases cannot be exhaustive. A skilled person in the art is able to select them on the basis of the nature of the product to be flavored. However, as examples of solvents commonly used in flavors, one can cite compounds such as propylene glycol, triacetine, triethyl citrate, benzylic alcohol, ethanol, vegetal oils or terpenes.

As solid carrier one may cite, as non-limiting examples, absorbing gums or polymers, or yet an encapsulating materials as explained in more details further below.

Generally speaking, by “flavor base” we mean here a composition comprising at least one flavoring co-ingredient.

Said flavoring co-ingredients are not of the formula (I). Moreover, by “flavoring co-ingredient” it is meant here a compound, which is used in flavoring preparation or composition to impart an hedonic effect. In other words such a co-ingredient, to be considered as being a flavoring one, must be recognized by a person skilled in the art as being able to impart or modify in a positive or pleasant way the taste of a composition, and not just as having a taste.

The nature and type of the flavoring co-ingredients present in the base do not warrant a more detailed description here, which in any case would not be exhaustive, the skilled person being able to select them on the basis of its general knowledge and according to intended use or application and the desired organoleptic effect. In general terms, these perfuming co-ingredients belong to chemical classes as varied as alcohols, aldehydes, ketones, esters, ethers, acetates, nitrites, terpene hydrocarbons, nitrogenous or sulphurous heterocyclic compounds and essential oils, and said perfuming co-ingredients can be of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of flavor.

A flavoring composition comprising at least one compound of formula (I) such as succinoyl-Glu, succinoyl-Ala and succinoyl-Leu, and/or a derivative thereof, is particularly useful from the organoleptic point of view.

In a particular embodiment of the invention, a flavoring composition wherein the flavor base comprises at least a flavoring co-ingredient selected from the group consisting of an extract derived from a single cell organism, a protein hydrolysate and a fat hydrolysate, has proved to be particularly useful as MSG replacer. Indeed, we have found that the presence of at least one of said flavoring co-ingredients increases or boosts the organoleptic effect provided by the invention's compounds.

As “extract derived from a single cell organism” we mean here an extract obtained by degradation, e.g. by autolysis, of a single cell organism such as a yeast. Examples of single cell organisms are Saccaromyces cerevisae and Torulla cells.

As “protein hydrolysate” we mean here the residue obtained by the degradation, e.g. hydrolysis, of a protein. Examples of such material are the product obtained by the hydrolysis of proteins of current use in the flavor industry such as caseine, soya proteins and pea proteins. In particular, caseine hydrolysates are very interesting.

As “fat hydrolysate” we mean here the residue obtained by the degradation, e.g. by enzymatic hydrolysis, of a fat. Examples of such material are hydrolised butter oil.

A preferred composition of said invention's embodiments is a flavoring composition wherein the flavor base comprises at least a yeast extract, at least a protein hydrolysate and at least a fat hydrolysate. Actually, in such an embodiment the unexpected synergies between the co-ingredients has been found to be very profitable for the intended use of said flavoring compositions, e.g. to impart remarkably rich and balanced organoleptic effects, e.g. fullness, volume and perception of the flavor, which are similar to, or more suitable than, those conferred by MSG.

The flavoring compositions according to the invention may be in the form of a simple mixture of flavoring ingredients or also in an encapsulated form, i.e. a flavoring composition entrapped into a solid matrix. The encapsulation process by which the aroma can be protected may consist of techniques such as spray-drying, agglomeration or yet extrusion; or consists of a coating encapsulation, including coacervation and complex coacervation techniques. Carrier materials used for matrices are wall-forming and plasticizing materials such as mono, di- or trisaccharides, natural or modified starches, hydrocolloids, cellulose derivatives, polyvinyl acetates, polyvinylalcohols, proteins or pectins. Example of particularly useful matrix materials include sucrose, glucose, lactose, levulose, fructose, maltose, ribose, dextrose, isomalt, sorbitol, mannitol, xylitol, lactitol, maltitol, pentatol, arabinose, pentose, xylose, galactose, maltodextrin, dextrin, chemically modified starch, hydrogenated starch hydrolysate, succinylated or hydrolysed starch, agar, carrageenan, gum arabic, gum accacia, tragacanth, alginates, methyl cellulose, carboxymethyl cellulose, hydroxyethyl cellulose, hydroxypropylmethyl cellulose, derivatives and mixtures thereof. Coating encapsulation is typically based on thin xerogel carrier systems including gelatin, agar and alginate. Other suitable carrier ingredients are cited in reference texts such as H. Scherz, Hydrokolloids: Stabilisatoren, Dickungs- und Giehermittel in Lebensmittel, Band 2 der Schriftenreihe Lebensmittelchemie, Lebensmittelqualität, Behr's VerlagGmbH & Co., Hamburg, 1996. The cited materials are hereby given by way of example and are not to be interpreted as limiting the invention.

It is useful to mention here that the possibility to have, in the compositions mentioned above, more than one compound of formula (I) or derivative thereof is important as it enables the flavorist to prepare flavors, possessing the flavor tonality or properties of various compounds of the invention, creating thus new tools for their work.

Its is also understood here that, unless otherwise indicated or described, any mixture resulting directly from a chemical synthesis, e.g. without an adequate purification, in which the compound of the invention would be involved as a starting, intermediate or end-product could not be considered as a composition according to the invention.

Generally speaking, by “flavor adjuvant” we mean here an ingredient capable of imparting additional added benefit such as a color, a particular light resistance, chemical stability, etc. A detailed description of the nature and type of adjuvant commonly used in flavoring bases cannot be exhaustive, but it has to be mentioned that said ingredients are well known to a person skilled in the art.

As previously mentioned, an invention's compound or composition is a useful flavoring ingredient which can be advantageously incorporated to flavored articles or foodstuffs to improve or enhance their taste. Consequently, a flavored article comprising:

i) at least one compound selected from the group consisting of a compound of formula (I), its edible alkaline or alkaline earth salts and the hydrates thereof, or an invention's composition; and

ii) a foodstuff base,

is also an object of the present invention.

For the sake of clarity, it has to be mentioned that, by “foodstuff base”, we mean here an edible product, e.g. a food or a beverage. Therefore, a flavored article according to the invention comprises the functional formulation, as well as optionally additional benefit agents, corresponding to an edible product, e.g. a stock, and a flavor effective amount of at least an invention's compound and optionally one or more solvents commonly used in flavors.

The nature and type of the constituents of the foodstuffs or beverages do not warrant a more detailed description here, which in any case would not be exhaustive, the skilled person being able to select them on the basis of its general knowledge and according to the nature of said product.

Suitable foodstuffs base, e.g. foods or beverages, may be of low-fat or classical, i.e. non-fat-reduced, type. By “low fat” we mean here a fat content which is 30%, preferably 50%, lower than in the classical article. Indeed, we have found that low fat and classical food products, and in particular the low fat ones, can be improved from the point of view of the umami and/or mouthfeel character using a compound or a flavoring composition according to the invention.

Suitable foodstuff bases comprise, for example, all savory foods, such as those of the meaty, poultry, fishy, vegetable, cheese and dairy types.

The proportions in which the compounds according to the invention can be incorporated into the various aforementioned articles or compositions vary within a wide range of values. These values are dependent on the nature of the article or product to be flavored and on the desired effect as well as the nature of the co-ingredients in a given composition when the compounds according to the invention are mixed with flavoring co-ingredients, solvents or additives commonly used in the art.

For example, typical concentrations from 0.05% to 0.25%, and preferably from 0.1% to 0.2%, by weight of these compounds, with respect to the food article in which they are incorporated, can be typically used. Of course, higher concentrations than these can be used when these compounds are incorporated into flavoring compositions.

The invention's compounds are prepared from commercially available products and using processes which make use of conventional reactions. For examples, one of the methods which can be used to synthesize the invention's compounds consists in reacting the starting diacid of formula HOOC—G—COOH, wherein G is as defined in formula (I), with approximately one molar equivalent of a proteogenic α-amino acid in the presence of carboxylic acid activators such as DCC (N,N′-dicyclohexylcarbodiimide) and N-hydroxysuccinimide. Alternatively, when applicable, it is possible to react together a proteogenic α-amino acid with approximately one molar equivalent of a suitable acid anhydride in a water/dioxane or water solution buffered at a pH comprised between 7.0 and 11, and without heating. Of course it is also possible to prepare the compounds of formula (I) by reacting the amino acid with an acid chloride derivative.

Said methods of preparation will now be described in further detail. The temperatures are indicated in degrees centigrade (° C.); ¹H-NMR spectral data were recorded at 400 MHz, and ¹³C-NMR at 100 MHz, in D₂O unless stated otherwise, the chemical displacement δ are indicated in ppm with respect to the TMS as standard, the coupling constant J are expressed in Hz and all the abbreviations have the usual meaning in the art.

General Methods

A) Reaction Between An Amino Acid And An Acid Anhydride

To a solution of the α-amino acid (1.5 moles) in 800 ml of demineralized water and having a pH of 9.3 (adjusted by using aliquots of concentrated NaOH) was added in small portions an equimolar amount of acid anhydride in powdered form. During the addition of the acid anhydride, and the reaction, the pH of the reaction medium was continuously monitored and, when necessary, maintained at a pH comprised between 8.7 and 9.5 by the controlled addition of aliquots of concentrated NaOH. After one night of stirring was added to the reaction medium an amount of a cation-exchanging resin in its acid form (e.g. Dowex® 50WX8) sufficient to drop the pH at a value of around 2-3. The resulting mixture was filtered, and the solution evaporated to dryness to obtain the invention's compound in its acidic form. Alternatively, if an edible salt is desired, prior the evaporation to dryness it is possible of adding an adequate amount of an adequate base. The product thus obtained had a purity of at least 90%, frequently more than 95%, the remaining being the dicarboxylic acid obtained by the hydrolysis of the starting anhydride.

B) Reaction Between An Amino Acid And A Diacid

To a solution of dicarboxylic acid (15 mmoles) and N-hydroxysuccinimide (16 mmoles) in 22.5 ml of dioxane and at 15° C., was added in 5 minutes DCC (16 mmoles). The mixture thus obtained was stirred during 4 hours and then the white precipitate filtered off. The solution thus obtained was added into a solution of the amino acid (17 mmoles), NaHCO₃ (17 mmoles) in 24 ml of demineralized water. After 18 hours of stirring at room temperature, the organic solvent was evaporated and the resulting water solution washed three times with ethyl acetate. The pH of the water phase thus obtained was adjusted to 2 by the addition of the Dowex® 50WX8 resin. After filtration of the resin, the pH of the water solution was adjusted to 5.5-6 by addition of 1 M aqueous NaOH, and then this crude solution was lyophilized to afford a crude product. The crude product was purified by preparative HPLC (conditions: Column Microsorb C18, 250*10 mm id. (Rainin), elution with 4ml/min of an isocratic mixture of water and acetonitrile 8/2 containing 0.2% of formic acid, detection: UV @ 214 nm).

C) Reaction Between An Amino Acid And An Acid Chloride

To a solution of acid dichloride, e.g. fumaryl dichoride, (0.25 moles) in 100 ml of dioxane was added, over two minutes, a solution of the amino acid, e.g. glutamic acid, (0.25 moles) and NaOH (4 molar equivalents) in 150 ml of a ½ mixture of water and dioxane. The pH of the resulting mixture was adjusted to 9.5 by adding aliquots of a 1M aqueous NaOH solution. After stirring for 90 minutes, the reaction mixture was washed with AcOEt and the water phase filtered through a column containing a cation-exchanging resin (e.g. Dowex® 50WX8). The water solution thus obtained was lyophilized to afford a crude product. The crude product was purified by preparative HPLC (conditions: Column Microsorb C18, 250*10 mm id. (Rainin), elution with 4 ml/min of an isocratic mixture of water and acetonitrile 8/2 containing 0.2% of formic acid, detection: UV @ 214 nm).

Succinoyl-Ala according to method A), yield 93% ^{‘}H-NMR: 4.33(q, J=7.2, 1H); 2.71-2.65(m, 2H); 2.61-2.57(m, 2H); 1.41(d, J=7.2, 3H) ¹³C—NMR: 179.98(s); 179.92(s); 171.5(s); 51.8(d); 32.8(t); 32.1(t); 19.2(q) MS: 190.0 (M+H⁺)

Succinoyl-Glu according to method A), yield 93% ¹H-NMR: 4.39(dd, J=8.5, J′=5.4, 1H); 2.69-2.65(m, 2H); 2.63-2.58(m, 2H); 2.48(t, J=7.4, 2H); 2.24-2.15(m, 1H); 2.03-1.94(m, 1H) ¹³C—NMR: 180.2(s); 180.0(s); 179.8(s); 177.8(s); 55.5(d); 33.1(t); 33.0(t); 31.9(t); 29.1(t) MS: 247.9 (M+H⁺)

Succinoyl-Leu according to method A), yield 72% ¹H-NMR: 4.33(dd, J=8.7, J′=5.1, 1H); 2.70-2.64(m, 2H); 2.61-2.53(m, 2H); 1.70-1.60(m, 3H); 0.93(d, J=5.6, 3H); 0.88(d, J=6.1, 3H) ¹³C-NMR: 180.5(s); 180.0(s), 177.7(s); 54.9(d); 42.6(t); 33.0(t); 32.3(t); 27.4(t); 25.2(q); 23.5(q) MS: 232.0 (M+H⁺)

Glutaryl-Leu sodium salt according to method A), yield 93% ¹H-NMR: 4.33(dd, J=9.7, J′=5.6, 1H); 2.46-2.39(m, 2H); 2.35(˜t, J=7.4, 2H); 1.93-1.85(m, 2H); 1.69-1.61(m, 3H); 0.93(d, J=6.1, 3H); 0.89(d, J=6.1, 3H) ¹³C-NMR: 180.7(s); 180.0(s); 178.8(s); 54.6(d); 42.4(t); 37.3(t); 35.7(t); 27.4(d); 25.1(q); 23.5(t); 23.4(q) MS: 246.0 (M+H⁺)

Glutaryl-Glu according to method A), yield 95% ¹H-NMR: 4.42(dd, J=9.2, J′=5.1, 1H); 2.51(t, J=7.4, 2H); 2.43(t, J=7.2, 2H); 2.37(t, J=7.4, 2H); 2.26-2.17(m, 1H); 2.06-1.93(m, 1H); 1.90(tt, J=7.4, J′=7.2, 2H) ¹³C-NMR: 180.7(s); 180.0(s); 178.9(s); 178.2(s); 55.0(d); 37.3(t); 35.7(t); 33.0(t); 28.7(t); 23.4(t) MS: 262.0 (M+H⁺)

Maleyl-Glu according to method A), yield 95% ¹H-NMR: 6.40(d, J=12.3, 1H); 5.96(d, J=12.3, 1H); 4.17(dd, J=8.7, J′=4.6, 1H); 2.27(t, J=7.7, 2H); 2.12-2.03(m, 1H); 1.96-187(m, 1H) ¹³C-NMR: 184.7(s); 181.8(s); 177.9(s); 169.8(s); 139.7(d); 126.0(d); 57.9(d); 36.6(t); 31.3(t) MS: 246.0 (M+H⁺)

Maleyl-Leu according to method A), yield 95% ¹H-NMR: 6.39(d, J=12.3, 1H); 5.94(d, J=12.3, 1H); 4.19(dd, J=9.2, J′=5.6, 1H); 1.73- 1.63(m, 1H); 1.62-1.57(m, 2H); 0.93(d, J=6.7, 3H); 0.90(d, J=6.7, 3H) ¹³C-NMR: 183.1(s); 177.6(s); 169.7(s); 139.5(d); 126.2(d); 56.8(d); 43.5(t); 27.4(d); 25.3(q); 23.6(q) MS:230.0 (M+H⁺)

Fumaryl-Glu according to method B), crude yield=71% ¹H-NMR: 7.02(d, J=15.4, 1H); 6.74(d, J=15.4, 1H); 4.52(dd, J=9.2, J′=5.1, 1H); 2.52(t, J=7.4, 2H); 2.31-2.22(m, 1H); 2.11-2.02(m, 1H) ¹³C-NMR: 180.1(s); 178.0(s); 172.3(s); 169.4(s); 138.1(d); 134.5(d); 55.7(d); 33.1(t); 28.9(t)

Malonyl-Leu according to method C), crude yield=80% Spectra in DMSO ¹H-NMR: 8.31(d, J=8.2, 1H); 4.23(dd, J=8.2, J′=7.8, 1H); 3.21, 3.12(AB, J=15.4, 2H); 1.70-1.60(m, 1H); 1.50(t, J=7.4, 2H); 0.89(d, J=6.7, 3H); 0.85(d, J=6.7, 3H) ¹³C-NMR: 173.8(s); 169.1(s); 165.6(s); 50.2(d); 40.1(t); 24.1(d); 22.7(q); 21.3(q)

The invention will now be described in further detail by means of the following examples in which the abbreviations have the usual meaning in the art. These examples represent typical ways of carrying out the invention and should not be interpreted restrictively, in particular as regards the relative or absolute proportion of the ingredients mentioned.

### EXAMPLES

The following examples are further illustrative of the present invention embodiments, and further demonstrate the advantages of the invention relative to the prior art teachings. The abbreviations have the usual meaning in the art.

### Example 1

Flavor Comprising An Invention Compound

Beef type flavors, A), B) and C), were prepared by admixing the following ingredients:

| | Parts by weight | | |
|---|---|---|---|
| Ingredient | A) | B) | C) |
| Beef 569547 THP0524¹⁾ | 5 | 5 | 5 |
| Firanova ® BB VEG MSF-587069¹⁾ | 300 | 300 | 300 |
| Citric acid | 10 | 10 | 10 |
| Garlic powder | 20 | 20 | 20 |
| Maltodextrin | 335 | 235 | 135 |
| Sodium diacetate | 30 | 30 | 30 |
| Salt | 300 | 300 | 300 |
| MSG | | 100 | |
| Succinoyl-Glu | | | 200 |
| Total | 1000 | 1000 | 1000 |

¹⁾Compounded flavor base; origin: Firmenich SA, Geneva, Switzerland

Three beef stock bases, A′), B′) and C′), were prepared by admixing the following ingredients:

| | Parts by weight | | |
|---|---|---|---|
| Ingredient | A′) | B′) | C′) |
| Beef fat | 5.00 | 5.00 | 5.00 |
| Salt | 35.00 | 35.00 | 35.00 |
| Toasted onion powder 607474¹⁾ | 2.00 | 2.00 | 2.00 |
| Beaded palm oil | 5.00 | 5.00 | 5.00 |
| Maltodextrin | 14.15 | 14.15 | 14.15 |
| Yeast extract²⁾ | 10.00 | 10.00 | 10.00 |
| Caramel color | 0.42 | 0.42 | 0.42 |
| Beef meat powder 3121 P³⁾ | 2.50 | 2.50 | 2.50 |
| Onion powder 01PEX⁴⁾ | 0.85 | 0.85 | 0.85 |
| White pepper | 0.08 | 0.08 | 0.08 |
| Flavour A) | 25.00 | | |
| Flavour B) | | 25.00 | |
| Flavour C) | | | 25.00 |
| Total | 100.00 | 100.00 | 100.00 |

¹⁾origin: McCormick, USA
²⁾GISTEX X-2; origin: DSM
³⁾origin: Nikken Foods
⁴⁾origin: Sodeleg

Using the three different stock bases mentioned above, at a level of 10 g per 500 g of hot water, there was obtained 3 broths. According to a panel of 5 expert flavorists, the tastes of the three broths were described as follows:

| | Broth with | | |
|---|---|---|---|
| | A′) | B′) | C′) |
| Taste | Meaty, beefy, little | Meaty, beefy, | Meaty, beefy, umami, |
| | mouthfeel, lacks in | sweet-umami, | round, good lasting. |
| | depth | round, good | Meatier and less sweet |
| | | lasting | than the broth with B′). |

In conclusion, the broths with B′) and C′) showed a quite similar profile of roundness and lasting of the taste. However, the latter have some differences, i.e. B′) provided a sweeter broth whereas C′) gave a broth with an enhanced meaty character.

1. A method to confer, enhance, improve or modify the flavor properties of a flavoring composition or of a flavored article, which method comprises adding to said composition or article an effective amount of at least one compound selected from the group consisting of
(a) an acid of formula 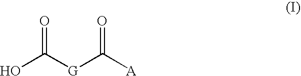
wherein G represents a linear C₁ to C₆ alkyl group or a HC═CH group having the carbon-carbon double bond in a E or Z configuration; and
A represents a proteogenic a-amino acid residue, said residue being bonded to the carbonyl group via the a-nitrogen atom; and
(b) the edible alkaline or alkaline earth metal salts, and the hydrates, of said compounds of formula (I).

2. Method according to claim 1, wherein the flavor properties includes umami character or mouthfeel or both.

3. A flavoring ingredient in the form of a composition comprising
i) at least one compound selected from the group consisting of
(a) an acid of formula 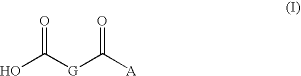
wherein G represents a linear C₁ to C₆ alkyl group or a HC═CH group having the carbon-carbon double bond in a E or Z configuration; and
A represents a proteogenic a-amino acid residue, said residue being bonded to the carbonyl group via the a-nitrogen atom; and
(b) the edible alkaline or alkaline earth metal salts, and the hydrates, of said compounds of formula (I);
ii) at least one ingredient selected from the group consisting of a flavor carrier and a flavor base; and
iii) optionally at least one flavor adjuvant.

4. A flavoring ingredient according to claim 3, wherein the flavor base comprises at least one flavoring co-ingredient selected from the group consisting of an extract derived from a single cell organism, a protein hydrolysate and a fat hydrolysate.

5. A flavoring ingredient according to claim 4, wherein the extract derived from a single cell organism is a yeast extract.

6. A flavoring ingredient according to claim 4, wherein the protein hydrolysate is a caseine hydrolysate, a soya protein hydrolysate or a pea protein hydrolysate.

7. A flavoring ingredient according to claim 4, wherein the fat hydrolysate is a hydrolysed butter oil.

8. A flavoring ingredient according to claim 4, wherein the flavor base comprises at least a yeast extract, at least a protein hydrolysate and at least a fat hydrolysate.

9. A flavored article comprising:
i) at least one compound selected from the group consisting of
(a) an acid of formula 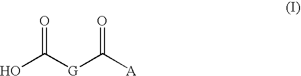
wherein G represents a linear C₁ to C₆ alkyl group or a HC═CH group having the carbon-carbon double bond in a E or Z configuration; and
A represents a proteogenic α-amino acid residue, said residue being bonded to the carbonyl group via the α-nitrogen atom; and
(b) the edible alkaline or alkaline earth metal salts, and the hydrates, of said compounds of formula (I);
or a composition as defined in claim 4; and
ii) a foodstuff base.

10. A flavored article according to claim 9, wherein the foodstuff base is in the form of a savory food.
